(19) United States
(12) Patent Application Publication
(10) Pub. No.: US 2011/0196623 A1
(43) Pub. Date: Aug. 11, 2011

(54) LOAD MONITORING SYSTEM

(76) Inventor: Seppo Häkkinen, Snakstone (GB)

(21) Appl. No.: 13/001,325

(22) PCT Filed: Jun. 24, 2009
(86) PCT No.: PCT/GB2009/001585

§ 371 Date: Apr. 26, 2011

(30) Foreign Application Priority Data
Jun. 24, 2008 (GB) 0811570.1

(51) Int. Cl. G06F 19/00

(52) U.S. Cl. 702/41

(57) ABSTRACT

A load monitoring system (5) is used to monitor the loading of a vehicle (1) by a load handling system (2) which is movable through a loading cycle to load a payload module (3) onto the vehicle (1) from the ground (4). The load monitoring system (5) comprises sensors (53) for sensing positional information and loading force information of the load handling system (2) at multiple positions during the loading cycle. A data processor (54) uses this information to calculate the mass of the payload module (3) and the position of the centre of gravity (31) of the payload module (3).

### Field of the Invention

The present invention relates to a load monitoring system for use in monitoring the loading of a vehicle, such as a military truck, by a load handling system which is carried by the vehicle. The invention is particularly, but not exclusively, applicable to a load handling system which is of the hook-lift type, wherein the load handling system is used to load a demountable payload module such as an ISO container or a flatrack.

### BACKGROUND OF THE INVENTION

National authorities impose limitations on the transportation of loads by trucks. Specifically, dimensional and weight limitations are imposed.

For example, a maximum overall weight of the vehicle (gross vehicle weight—GVW) is often specified and is generally dependent on how many axles the vehicle has. The load on an axle is limited in order to protect the road surface and bridges.

Safety devices are employed in modern trucks to protect the truck from overturning or becoming uncontrollable. However, in cross-country travel or when travelling on unsurfaced roads, electronic safety devices are usually switched off because the truck usually has big wheel or tyre dimensions and carries a large mass and will undergo long suspension travel when travelling on the unsurfaced road or when travelling cross-country. Electronic safety devices such as ABS, ESR and EDS are generally designed for road-going vehicles which have a small tyre size and only have limited suspension travel when those vehicles are driving on surfaced roads at relatively high speed.

A load handling system of the hook-lift type is often used to lift a demountable payload module (such as ISO container or flatrack) onto a vehicle, when the driver (operator of the vehicle) has no information about the weight (or mass) of the load carried in or on the ISO container or flatrack, and no information about the distribution of the load, e.g. whether the distribution of the load is such that the centre of gravity of the payload module with the load is too far forwards or backwards, or too far to one side. This lack of information is a particular problem with closed containers, because the driver cannot even see the load contained within the container.

The driver is deemed to be responsible for the safety of the vehicle in order to protect the vehicle itself from having an accident and in order to stop the vehicle from damaging or injuring adjacent objects such as other vehicles or people. However, in spite of this responsibility, the driver has no way of determining how safe the load is that is being carried in or on the demountable payload module.

In relation to considering the safe transportation of the demountable payload module with its load, the driver needs to take into account: (1) the overall weight or mass of the truck and payload module with its load to ensure that the gross vehicle weight is not exceeded; and (2) the position of the centre of gravity of the load or the payload module with its load and, specifically, (2a) the longitudinal position of the centre of gravity to ensure that no particular axle is overloaded and to ensure braking safety, (2b) the lateral position of the centre of gravity to ensure the vehicle does not tip over when cornering and that it can travel safely cross-country and (2c) the height of the centre of gravity to ensure stability when cornering and safe travel when travelling cross-country and safe braking.

In addition to the technical world of demountable payload modules (such as ISO containers, flatracks and skip bodies), there is also the technical world of permanently-mounted tipper bodies. Specifically, a tipper body is permanently pivotably mounted at one end to the rear end of a vehicle chassis. The front end of the tipper body may be raised in order to tilt the tipper body backwards in order to discharge or tip out a load onto the ground.

GB-2,191,868 relates to a vehicle load display. The document discloses that a display screen is placed in the cab of a tipper vehicle, and the display screen can be used to display the centre of gravity of the load in the longitudinal direction of the vehicle and the lateral direction of the vehicle. Also, the total weight of the load can be displayed on the panel of the display screen. The information displayed on the display screen is produced by an analyser which receives input signals from strain gauges adjacent to the two rear pivots of the tipper body, and from a pressure sensor which senses the pressure in a hydraulic cylinder at the front end of the tipper body. The measurements are made when the tipper body is sitting on the vehicle chassis and when a load (such as gravel) is being added into the tipper body. Because the tipper body is permanently mounted to the vehicle chassis, and has only one position (horizontal position) when the measurements are being made, it is relatively straightforward to calculate the longitudinal and lateral positions of the centre of gravity of the load (e.g. gravel) in the tipper body, and the total weight of the load, as explained in GB-2,191,868. Because the pivot of the tipper body has a fixed position relative to the vehicle chassis, it is easy to define the position of the tipper body relative to the chassis. A demountable payload module is more complex because it moves horizontally and vertically relative to the vehicle chassis.

JP-8233640 relates to a load weight measuring device for a cargo handling vehicle. An English-language abstract on the Espacenet database explains that this document discloses a vehicle having a load handling system of the hook-lift type. The pressure in a cylinder of the load handling system is measured in order to determine the weight of the load in the demountable payload module (container). During unloading, the unloading operation is interrupted, and it is then that the cylinder pressure is measured in order to determine the weight of the load. Thus, it can be seen that the determination of the weight of the load is made during unloading, and involves making a measurement at a single position during the unloading cycle. However, in order to determine the weight of the load from the measurement at the single position, it is necessary to assume that the load is evenly distributed in the container, and often this will not be the case.

### SUMMARY OF THE INVENTION

According to a first aspect of the present invention, there is provided a load monitoring system for use in monitoring the loading of a vehicle by a load handling system which is carried by the vehicle and is releasably connectable to a demountable payload module positioned on the ground and is movable through a loading cycle to load the payload module onto the vehicle from the ground. The load monitoring system may comprise one or more sensors for sensing positional information and loading force information of the load handling system. This sensing may be done at a plurality of positions during the loading cycle. A data processor may be provided to determine the (for example, longitudinal) position of the centre of gravity of the payload module. The data processor may determine the mass of the payload module. The data processor may make use of the positional information and loading force information sensed by the sensors during the loading cycle.

Thus, the load monitoring system may determine, in the technical world of demountable payload modules, the longitudinal position of the centre of gravity of the payload module, which assists in preventing overloading of the axles of the vehicle.

The demountable payload module may be, for example, an ISO container, a flatrack such as to the NATO specification, a skip body, or a basic or special-purpose module with an integral sub-frame such as a command and communication shelter, a medical unit, or a water tank container. The payload module may be empty or, as is more relevant in the context of the present invention, may carry a load, and references to a “payload module” mean the payload module per se without any load if the payload module is empty, or with a load if the payload module is carrying a load.

Preferably, the information is sensed at at least two positions during the loading cycle. The information may be sensed more often, such as at at least three positions, or at at least four positions. More preferably still, the information is sensed substantially continuously during the loading cycle.

Preferably, the data processor is also constructed and arranged to determine the lateral position of the centre of gravity of the payload module.

Knowing the lateral position of the centre of gravity of the payload module assists in ensuring that the vehicle will be stable when cornering or when going cross-country. Preferably, the information is sensed at at least three positions during the loading cycle, although as already mentioned it is even more preferable that the information should be sensed substantially continuously.

Preferably, the load monitoring system further comprises a sensor for sensing lateral inclination information of the load handling system. For example, an inclinometer may be mounted on the load handling system or the vehicle chassis.

Preferably, the data processor is also constructed and arranged to determine the height of the centre of gravity of the payload module. Preferably, the information is sensed at at least four positions during the loading cycle. However, as already mentioned, it is even more preferable that the sensing should occur substantially continuously throughout the loading cycle.

In the preferred embodiment, the load monitoring system further comprises a sensor for sensing longitudinal inclination information of the load handling system. A single two-axis inclinometer may be provided in order to sense both lateral inclination information and longitudinal inclination information.

In the preferred embodiment, the load monitoring system further comprises a display and the data processor is constructed and arranged to produce a display output for displaying on the display information relating to the centre of gravity of the payload module and/or the mass of the payload module.

In our preferred embodiment, the display output is arranged to display a diagrammatic plan view of the payload module depicting the location of the centre of gravity of the payload module.

For example, the diagrammatic plan view may depict the situation as if the payload module is fully loaded at the end of the loading cycle. Preferably the plan view shows not just the payload module but also the vehicle on which the payload module is mounted so that, for example, the depiction of the cab as part of the vehicle will help to orientate the viewer when looking at the plan view.

For example, the depiction of the payload module may be split into zones (e.g. four quarters) and if the centre of gravity crosses a threshold in the direction of a particular zone, away from a central position, then the respective zone may give a visual indication. For example, with four zones corresponding to front right, front left, rear right and rear left of the payload module, it is possible to display both longitudinal and lateral centre of gravity information. For example, if there is an overload in a particular zone, causing the centre of gravity to be located in that zone of the payload module, the zone may be given a first colour (e.g. orange) to indicate a first (low) level of overload, and may be given a second colour (e.g. red) to indicate a second (high) level of overload.

Alternatively or additionally, the display output is arranged to display a diagrammatic side view of the payload module depicting the location of the height of the centre of gravity of the payload module.

The display may be capable of switching between the plan view and the side view, or it may be capable of showing both views. The side view may also display the location of the longitudinal centre of gravity of the payload module.

Preferably, the display output is arranged to diagrammatically depict the mass of the payload module.

For example, there may be a symbol which changes colour as the mass increases. A suitable symbol might be a circle, or a warning triangle. For a low (acceptable) mass below a threshold value, the symbol may have a first colour (e.g. green). For a higher (unacceptable) mass above the threshold value, the symbol may have a second colour (e.g. orange). For an even-higher mass above a higher threshold value, the symbol may have a third colour (e.g. red).

The symbol may be superimposed on the diagrammatic plan view and/or the diagrammatic side view. For example, the symbol could be positioned at the centre of the zones of the diagrammatic plan view and/or the similar zones of the diagrammatic side view.

In a particular embodiment, the load monitoring system further comprises an audible output device and the data processor is constructed and arranged to produce an audio output for producing an audible output from the audible output device relating to the centre of gravity of the payload module and/or the mass of the payload module.

For example, if the mass of the payload module exceeds a (safe) threshold value, the audible output could warn the vehicle operator (driver). For example, there could be a warning sound (such as a buzzer) and/or a message (such as “Dangerously heavy load. Stop the loading.”). If the centre of gravity is too far away from the centre of the payload module, the audible output could be a message (such as “Centre of gravity is dangerously off centre towards the front right [or whichever zone(s) is or are affected] of the payload module. Unload the payload module and redistribute the load.”).

Preferably, the load handling system is of the hook-lift type, and the sensors are arranged to sense positional information indicative of the position of the hook of the load handling system.

The hook-lift type may be the sliding hook arm type or the tilting hook arm type.

From the position of the hook, the data processor may determine the position of the payload module based on stored information relating to the geometry of the load handling system on the vehicle and the geometry of the payload module.

For example, the geometry of the load handling system may include the configuration of the middle frame, the hook arm and the hook and the positioning of the middle frame relative to the vehicle chassis and the configuration and positioning of the rear rollers (for a flatrack) and/or rear roller assemblies (for an ISO container) relative to the vehicle chassis.

The geometry of the payload module may include its configuration (dimensions) including the position of the hook bar which is grabbed by the hook of the load handling system.

Physical dimensions, positions of pivot points, cylinder minimum and maximum lengths etc. can be measured and stored in the data processor in advance.

In our current embodiment, the sensors are arranged to sense positional information comprising the extension length of middle frame cylinder(s) and the extension length of hook arm cylinder(s) of the load handling system.

This information may be sensed indirectly, e.g. by measuring the volumetric flow of hydraulic oil into the cylinder(s) and integrating that flow to calculate extension length. Alternatively, the sensing may directly measure extension length, e.g. optically or mechanically.

In our current embodiment, the sensors arranged to sense positional information comprise a sensor which detects a middle-frame-down condition and/or a sensor which detects a hook-arm-down condition.

This information may be termed “equipment status information” as it reflects the status of the load handling system. The sensors (e.g. switches) may supplement the positional information regarding cylinder extension length and provide reassurance to the data processor regarding the exact position of the middle frame and/or hook arm. For example, if there is any inaccuracy in measuring cylinder extension length, the inaccuracy can be overridden when the sensor indicates that the middle frame is fully down and/or that the hook arm is fully down on (seated on) the middle frame.

In our current embodiment, the sensors are arranged to sense loading force information comprising the hydraulic pressure of middle frame cylinder(s) and preferably also the hydraulic pressure of hook arm cylinder(s) of the load handling system.

These pressures are indicative of the loading force imposed on the hook of the load handling system by the payload module.

The force could instead be measured by strain gauges on the load handling system.

The force on the hook will change in magnitude and direction as the loading cycle progresses. The force on the hook at a particular position of the loading cycle (e.g. indicated by the position of the hook, which indicates the position of the payload module, which indicates the position in the loading cycle) enables force-balance equations (algorithms) to be set up by the data processor relating the force on the hook (or, as proxies, the pressures in the cylinders, or the forces measured by the strain gauges) to the current position of the payload module including how the payload module is supported by the ground and/or by (rear rollers or rear roller assemblies of) the load handling system.

The force-balance equations are basic mathematical equations based on trigonometry and static force calculations. In other words, when the hook position is known (using trigonometry) and the internal forces of the load handling system are known (from the pressure sensors or strain gauges), equations based on Newton's laws (the loading force is balanced by the internal reaction force) can be set up. The equations are stored in the data processor as algorithms. The algorithms are structured to read the sensed data (pressure, position) and preferably display the result.

As the loading cycle progresses, a plurality of different equations can be set up, and the data processor can then solve the equations to determine centre of gravity position(s) and the mass of the payload module.

Lateral and/or longitudinal inclination information may be included in the equations because the vehicle (and the load handling system) will move as the loading cycle progresses. For example, the vehicle will rock backwards and then forwards as it picks up and loads a payload module up and over the rear end of the vehicle. Also, if the centre of gravity of the payload module is laterally off centre, the vehicle will rock to one side as the load handling system picks up and loads the payload module. The lateral inclination information enables the position of the lateral centre of gravity of the payload module to be calculated.

In our preferred embodiment, the data processor is arranged, at an early stage in the loading cycle, to produce estimates of the centre of gravity of the payload module and/or the mass of the payload module based on early-stage information sensed by the sensors, and at a later stage in the loading cycle to produce improved estimates based on later-stage information sensed by the sensors.

Preferably, the data processor is arranged repeatedly to produce improved estimates at successive stages in the loading cycle.

For example, the sensing and calculation may occur substantially continuously during the loading cycle to keep on improving the estimates until final values are produced.

For example, an estimate of the mass of the payload module may be calculated soon after initial pick-up at the beginning of the loading cycle. The final value cannot be calculated at this stage because part of the payload module (the rear end of the payload module) is still on the ground. Even so, the estimate of the mass can be used to warn the operator if, for example, it is apparent from the estimate that there is a significant overload. When the loading cycle progresses and all of the payload module is supported on the load handling system, the final value of the mass can be determined.

For example, the final value of the longitudinal position of the centre of gravity of the payload module may be determined when the middle frame is down.

For example, the final value of the lateral position of the centre of gravity of the payload module may be determined when the hook arm is down at the end of the loading cycle.

In our preferred embodiment, the data processor is arranged to receive an input signal indicating the type of payload module to be loaded by the load handling system. Thus, the data processor is able to perform “load type recognition”. Many load handling systems are designed to be used with different types of demountable payload modules so that, for example, the vehicle can switch from carrying an ISO container to carrying a flatrack. This “interoperability” is a desirable feature for a load handling system.

The input signal may let the data processor know which set of stored data (and equations) to use, e.g. those for a twenty-foot ISO container or those for a twenty-foot flatrack. The input signal may be generated, for example, as a result of the driver deploying the rear rollers (for loading a flatrack) or the rear roller assemblies (for loading an ISO container).

In our preferred embodiment, the data processor is arranged to produce a control output for influencing the operation of the load handling system and/or vehicle based on the centre of gravity position and/or mass determined by the data processor.

For example, the control output may be fed into the existing control system(s) of the load handling system and vehicle.

The control output might be used for stopping the loading cycle. For example, this may be done in response to the mass of the payload module exceeding a threshold value. This value may be set such as to prevent dangerous overloading of the vehicle.

The control output might be used to disable movement of the vehicle. Thus, for example, the driver can be prevented from driving away the vehicle if the mass of the payload module is producing an overload, and/or if the weight distribution is too far off centre and produces an off-centre centre of gravity of the payload module which could cause a stability or safety problem if the vehicle were to drive off.

According to a second aspect of the present invention, there is provided a load handling system fitted with a load monitoring system in accordance with the first aspect of the present invention. Preferably, the load handling system is of the hook-lift type, such as the tilting hook arm type.

According to a third aspect of the present invention, there is provided a vehicle fitted with a load handling system according to the second aspect of the present invention.

According to a fourth aspect of the present invention, there is provided a method of monitoring the loading of a vehicle by a load handling system by using a load monitoring system in accordance with the first aspect of the present invention.

The mass of the payload module may be calculated based solely on positional data and internal force data of the load handling system, without needing external force data such as from load cells that are positioned between the load handling system and the vehicle chassis.

According to a fifth aspect of the present invention, there is provided a method of retrofitting a load monitoring system in accordance with the first aspect of the present invention to a vehicle having a chassis on which is mounted a load handling system, wherein the sensors of the load monitoring system are fitted without demounting the load handling system from the chassis.

Preferred, non-limiting embodiments of the present invention will now be described with reference to the accompanying drawings.

### BRIEF DESCRIPTION OF THE DRAWINGS

FIGS. 1 to 4 are diagrammatic side views of a vehicle having a load handling system and showing a sequence of four steps from the beginning to the end of a loading cycle wherein the load handling system loads a demountable payload module (an ISO container) up and over the rear end of the vehicle and onto the vehicle.

FIG. 5 is a view of a display of a preferred embodiment of a load monitoring system in accordance with the present invention, wherein the display is positioned in the cab of the vehicle of FIGS. 1 to 4.

FIG. 6 is an enlarged view of the diagrammatic plan view of a vehicle with payload module as displayed on the display of FIG. 5.

FIGS. 7 to 24 show different permutations of the depiction, on the diagrammatic plan view of FIG. 6, of the location of the centre of gravity of the payload module and the mass of the payload module, wherein the information relating to the status of the position of the centre of gravity is indicated by the four quarters, and the information relating to the status of the mass of the payload module is illustrated by the central circle.

FIG. 25 is a flow diagram for use in explaining the overall operating principle of a load monitoring system in accordance with the present invention.

FIG. 26 is a flow diagram useful for explaining the calculation at initial pick-up during the loading cycle.

FIG. 27 is a flow diagram useful for explaining the calculation of payload module position.

FIG. 28 is a flow diagram useful for explaining the calculation of the force experienced by the load handling system.

FIG. 29 is a flow diagram useful for explaining the calculation of the position of the centre of gravity of the payload module.

FIG. 30 is a flow diagram useful for explaining checks performed to verify the accuracy of positional information.

FIG. 31 is a diagram illustrating the major components of a preferred embodiment of a load monitoring system in accordance with the present invention and showing how the load monitoring system may interact with the vehicle control system.

FIG. 32 is a diagrammatic side view of a load handling system of the hook-lift type and showing how a data processor of a load monitoring system in accordance with the present invention may set up an equation for a static force calculation at the initial pick-up stage of the loading cycle.

### DESCRIPTION OF THE PREFERRED EMBODIMENTS

The preferred embodiments are only examples and should not be taken to be limiting of the scope of the invention.

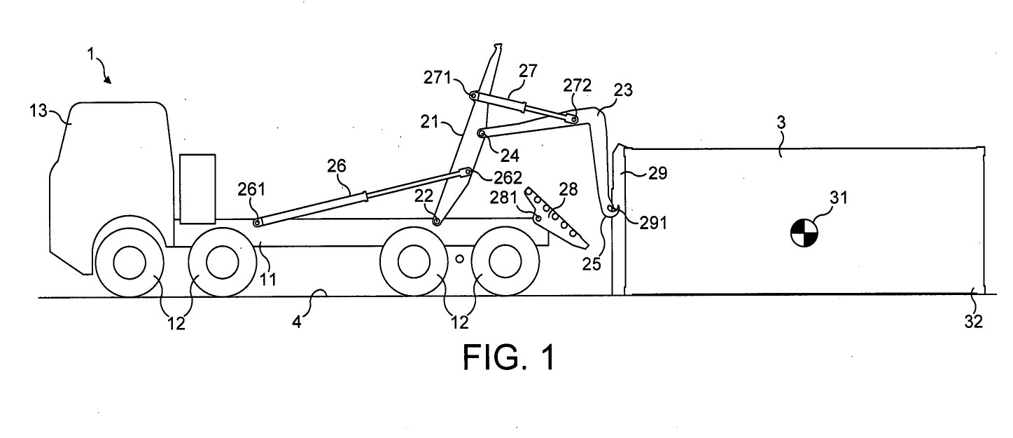

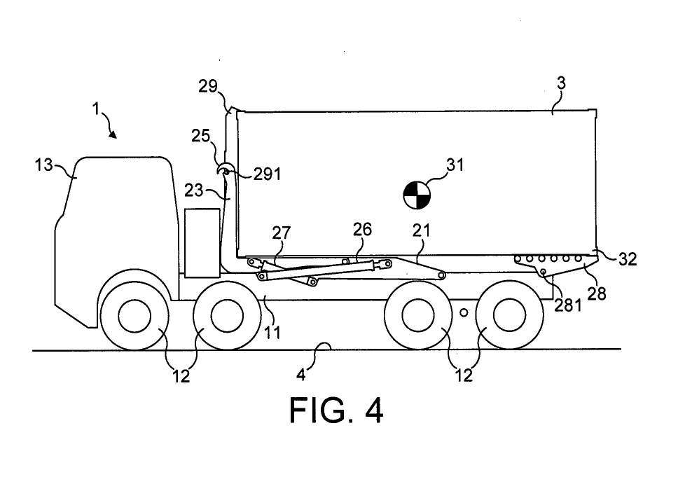

Referring to FIGS. 1 to 4, there is shown the loading cycle of a load handling system from initial pick-up (FIG. 1) through to completion of the loading (FIG. 4).

A vehicle (1) comprises a chassis (11) supported on four sets of wheels (12) mounted on respective axles. A cab (13) is mounted at the front end of the chassis (11).

A load handling system (2) is of the hook-lift type, and specifically is of the tilting hook arm type. It comprises a middle frame (21) which is connected via a pivot (22) to the chassis (11). A hook arm (23) is connected via a pivot (24) to the middle frame (21). The hook arm (23) incorporates a hook (25) at its free end.

A pair of middle frame cylinders (26) are each positioned on a respective side of the middle frame (21) and are connected via pivots (261) to the chassis (11) and via pivots (262) to the middle frame (21). The middle frame cylinders (26) are used to pivot the middle frame (21) about the pivot (22).

A pair of hook arm cylinders (27) are positioned one on each side of the middle frame (21) and hook arm (23). Each hook arm cylinder (27) is connected via a pivot (271) to the middle frame (21) and via a pivot (272) to the hook arm (23). The hook arm cylinders (27) served to articulate or pivot the hook arm (23) relative to the middle frame (21).

The load handling system (2) also incorporates rear roller assemblies (28) which are connected via pivots (281) to the rear end of the chassis (11).

The load handling system (2) also includes a container handling unit (CHU) which locks on to the front end of a container (3) in order to function as an adaptor between the container (3) and the articulated arms (21, 23) of the load handling system. The container handling unit (29) includes a hook bar (291) at an appropriate height to be lifted by the hook (25) at initial pick-up of the loading cycle.

The container (3) is a twenty-foot ISO container and it is a “demountable payload module” that can be loaded onto the vehicle (1) over the rear end of the vehicle by the load handling system (2). The loading cycle can also be reversed so that the load handling system (2) can return the container (3) back down onto the ground (4).

The container (3) has a centre of gravity (31) which is shown in FIGS. 1 to 4 at the position for an unloaded container (i.e. when the container contains no internal load). This position is also the position of the centre of gravity that would result from when the container (3) is substantially evenly filled with a load.

The container (3) is a payload module when (i) it contains no internal load and (ii) it does contain an internal load.

FIG. 1 shows the beginning of the loading cycle at initial pick-up of the container (3). The container handling unit (29) has been fitted to the front of the container (3) and the hook (25) has been brought into engagement with the hook bar (291).

The loading cycle should preferably be performed when the vehicle (1) is on firm and even ground (4). The brakes of the vehicle are applied only when no part of the container (3) is in contact with the ground. Initially, the brakes of the vehicle are not applied so that the vehicle may move backwards as the load handling system (2) operates and starts to lift up the container (3). The gear lever of the vehicle is left in the “neutral” position during the loading cycle. These conditions will help to ensure accurate calculations by the load monitoring system, as later described.

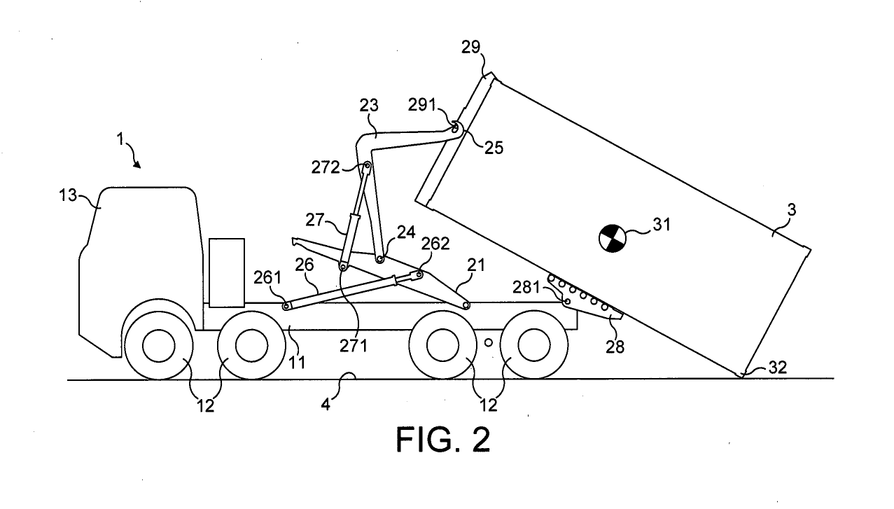

In moving from FIG. 1 to FIG. 2, the middle frame cylinders (26) are contracted in length. This lifts up the front (left) end of the container (3) and the vehicle (1) is pulled backwards until the rear roller assemblies (28) are in contact with the underside of the container (3) as shown in FIG. 2.

Further contraction of the middle frame cylinders (26) lifts the rear (right) end (32) of the container (3) off the ground (4) so that, for the rest of the loading cycle, all of the weight (mass) of the container (3) is now resting on the components of the load handling system (2).

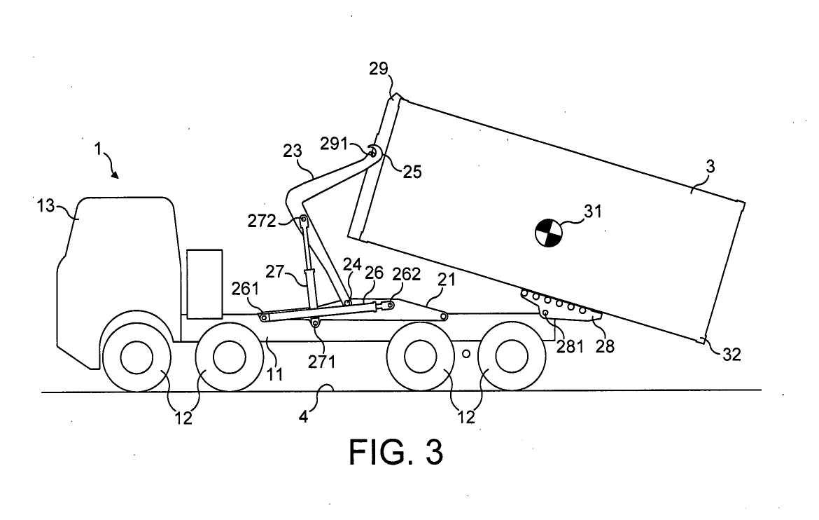

In moving from FIG. 2 to FIG. 3, the further contraction of the middle frame cylinders (26) moves the middle frame (21) to a “middle frame down” position as shown in FIG. 3 and also moves the container (3) further forwards onto the vehicle (1).

For the final part of the loading cycle, in moving from FIG. 3 to FIG. 4, the further movement of the container (3) is produced by contracting the length of the hook arm cylinders (27) such that the hook arm (23) pivots relative to the middle frame (21) and drags the container (3) forwards to its fully-loaded position shown in FIG. 4. In this configuration, the hook arm (23) is in a “hook arm down” position having completed its range of movement.

In moving from the position shown in FIG. 2 to the position shown in FIG. 4, the underside of the container (3) is slidably supported by the rollers of the rear roller assemblies (28). There are two such roller assemblies (28) positioned on respective sides of the vehicle (1) with a separation therebetween corresponding to the width of the container (3). In this way, the rear roller assemblies (28) serve to support the outer edges of the underside of the container (3).

Rear rollers (not shown) for supporting the rails underneath a flatrack are positioned between the rear roller assemblies (28), but they do not interfere with the loading operation for the container (3).

When the container (3) is fully loaded, as shown in FIG. 4, twistlocks may be used to lock down the four corners of the container (3).

If, alternatively, a flatrack had been loaded by the load handling system (2), automatic bodylocks would be used to lock down the rails underneath the platform of the flatrack.

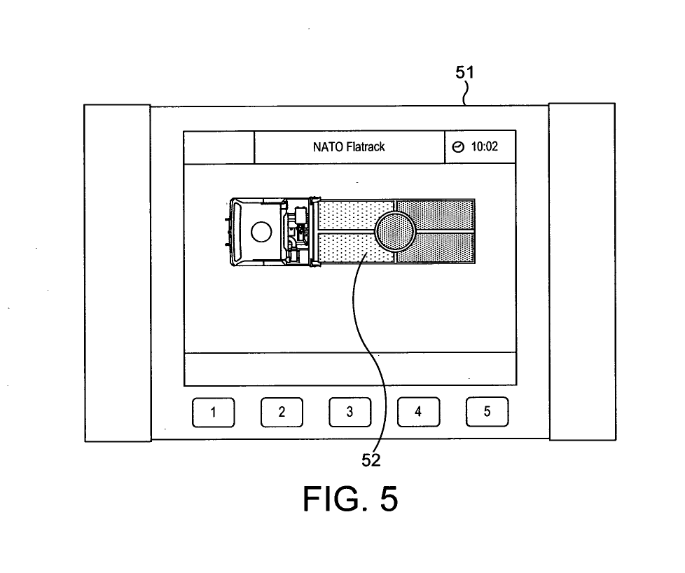

A load monitoring system (5) in accordance with the present invention includes a display (51) as shown in FIG. 5. The display (51) is conveniently positioned in the cab (13) adjacent to the other controls used by the driver, but it is possible for the display (51) to be positioned elsewhere on the vehicle or remote from the vehicle, e.g. connected via a wireless link.

As shown in FIG. 5, the display (51) is displaying a diagrammatic plan view (52) of a vehicle with a payload module mounted thereon.

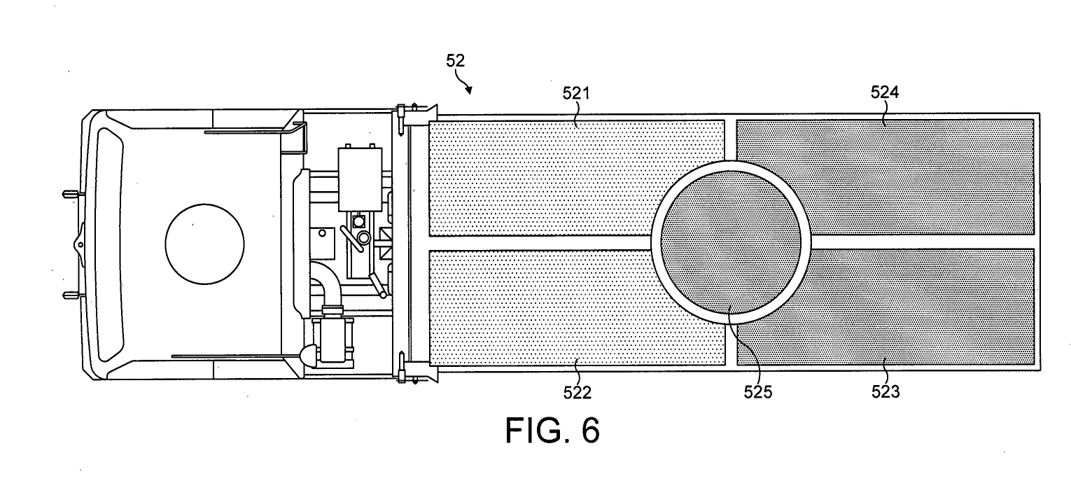

The diagrammatic plan view (52) is shown in more detail in FIG. 6. The area corresponding to the depiction of the payload module is split into four quarters (521, 522, 523, 524) corresponding respectively to the front right, front left, rear left and rear right quarters of the payload modules.

The diagrammatic plan view (52) also includes a central circle (525).

The quarters or zones (521-524) are used to depict an unbalanced load of the payload module wherein the centre of gravity of the payload module has moved beyond a threshold distance from a central position in the direction of the respective quarter or zone.

Because the diagrammatic view (52) is a plan view, it can be used to depict excessive offsets of the centre of gravity in the longitudinal and lateral directions of the payload module. Thus, if the centre of gravity of the payload module is too far towards the front right of the payload module, the zone (521) can give a warning.

If the centre of gravity is too far to the front left, the zone (522) can give a warning. If the centre of gravity is too far to the rear left, the zone (523) can give a warning. If the centre of gravity is too far to the rear right, the zone (524) can give a warning.

These warnings may be given by, for example, a change in colour from, for example, a green colour which illustrates a safe situation to an orange colour which indicates a low degree of undesirable offsetting of the centre of gravity, through to a red colour which illustrates a high degree of dangerous offsetting of the centre of gravity from the central position.

If the centre of gravity of the payload module is simply too far forwards, and is not laterally offset, the two zones (521 and 522) may be used to give a warning. If the centre of gravity is too far rearwards, the two zones (523 and 524) may be used to give a warning.

If the centre of gravity is at the correct longitudinal position, and the only incorrect offset is in the lateral direction, the two zones (522 and 523) may be used to indicate that the offset is to the left. The two zones (521 and 524) may be used to illustrate that the offset is to the right.

Superimposed on top of this visual illustration of any excess offsetting of the centre of gravity of the payload module is the information given by the central circle (525), which is used to display information relating to the calculated mass of the payload module.

If the mass of the payload module is under a threshold value, the central circle may, for example, be given a green colour. If the calculated mass is above a threshold value such that the payload module should be unloaded from the vehicle and some of the mass removed in order to return the total mass to below the threshold value, then the central circle (525) could be given, for example, an orange colour. If the mass is calculated as being above a second, higher threshold value presenting a higher degree of danger, the central circle (525) could be given, for example, a red colour.

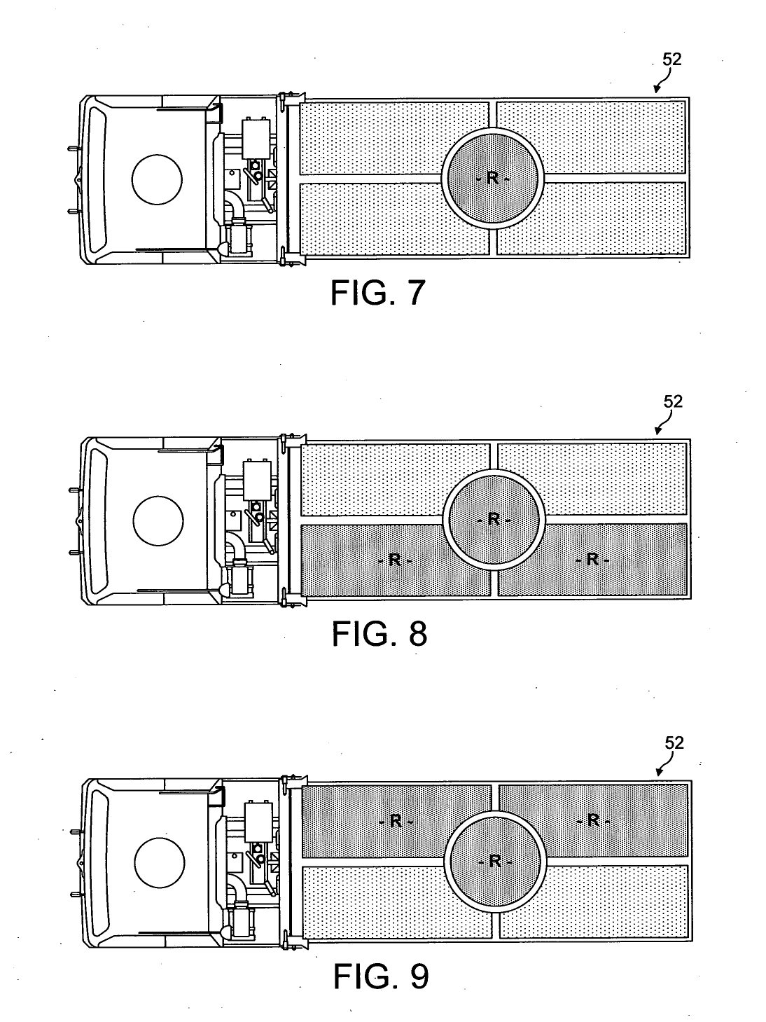

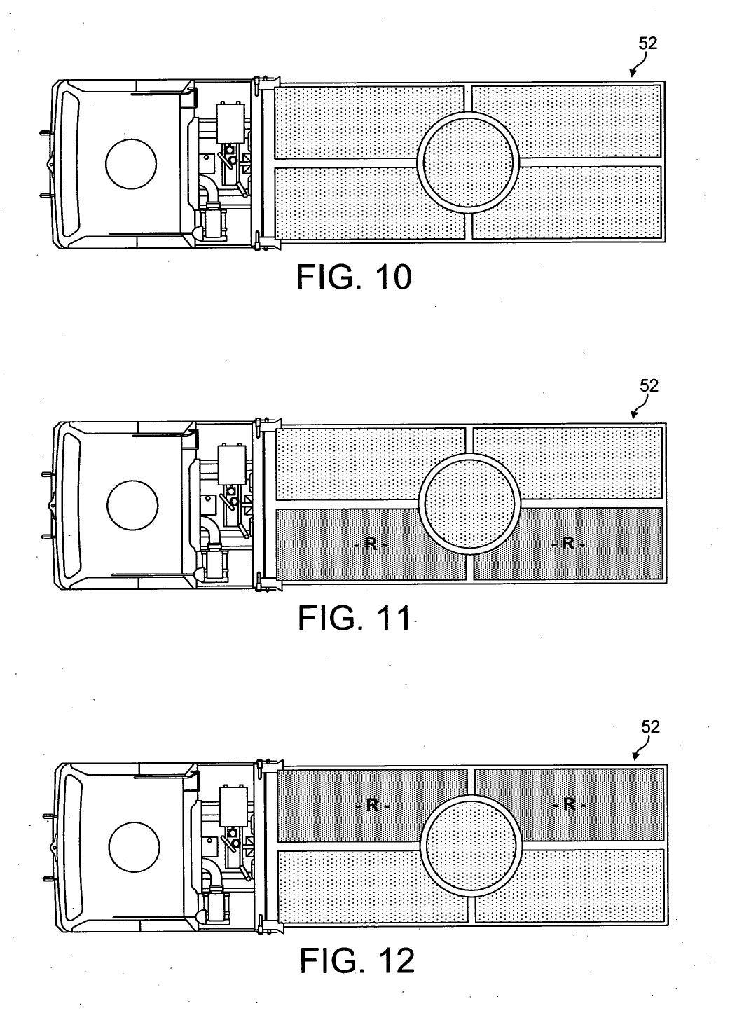

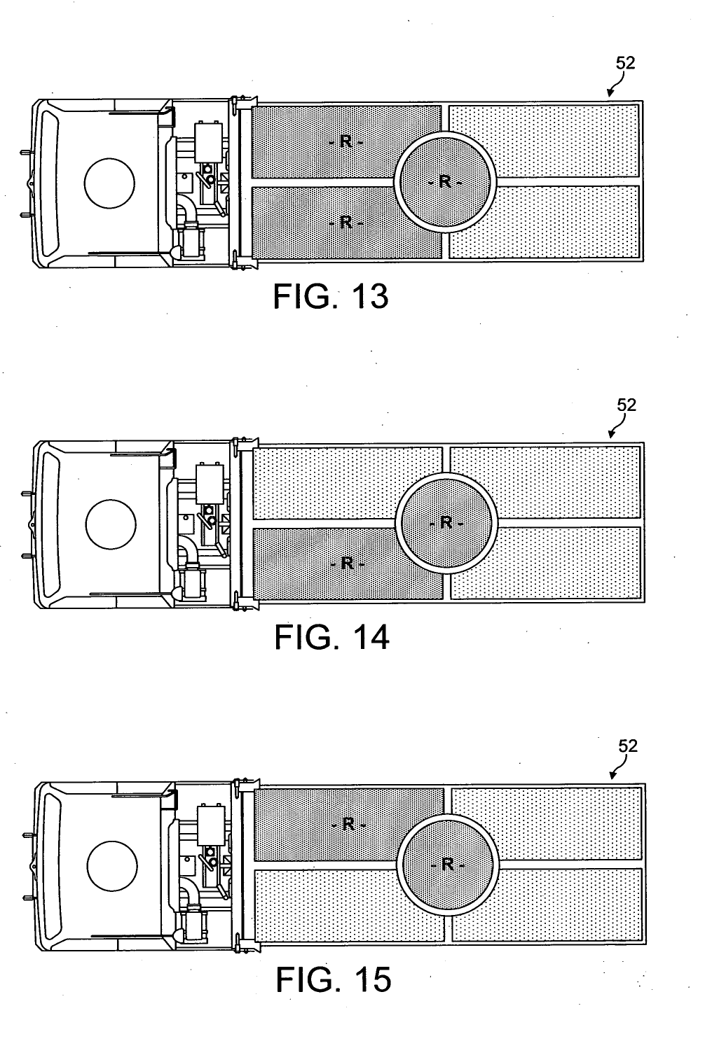

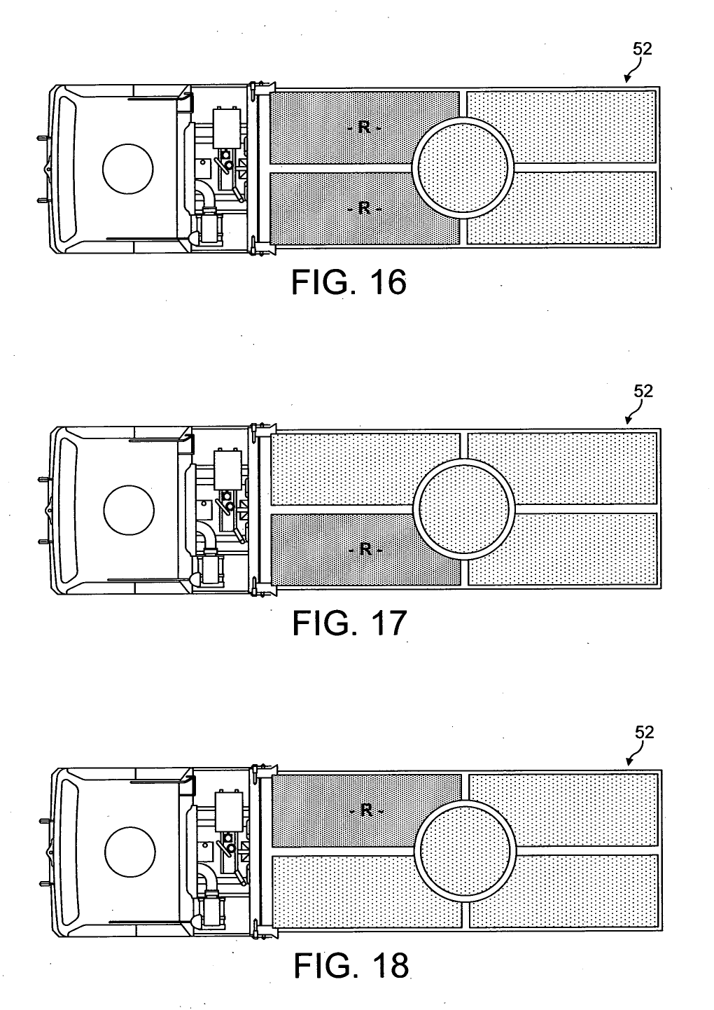

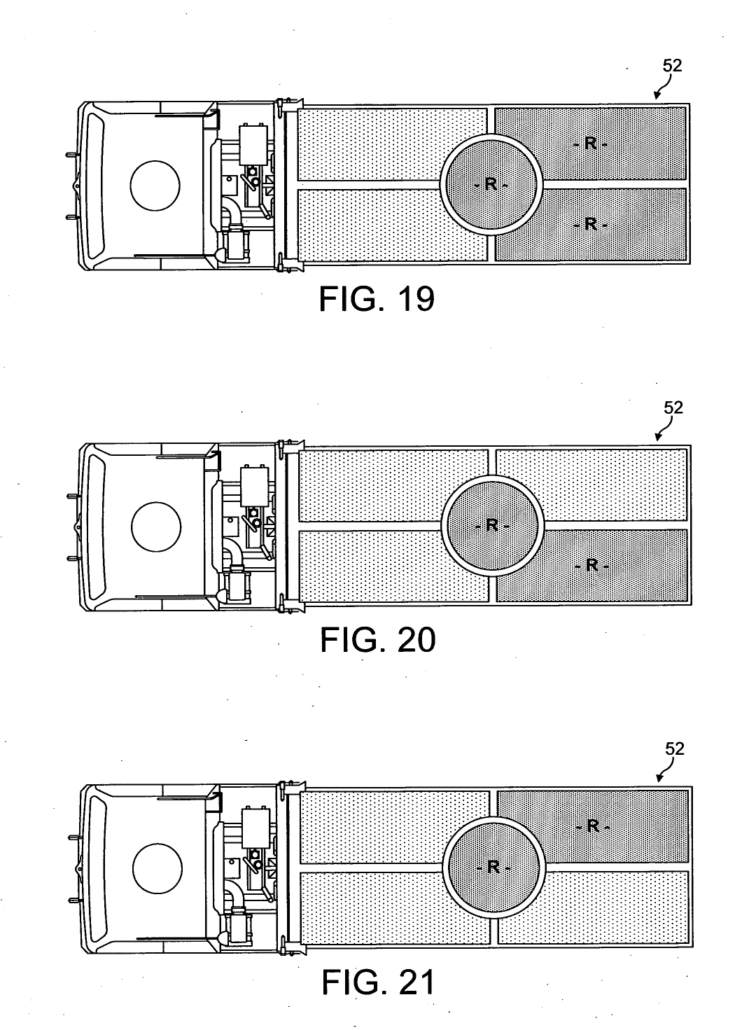

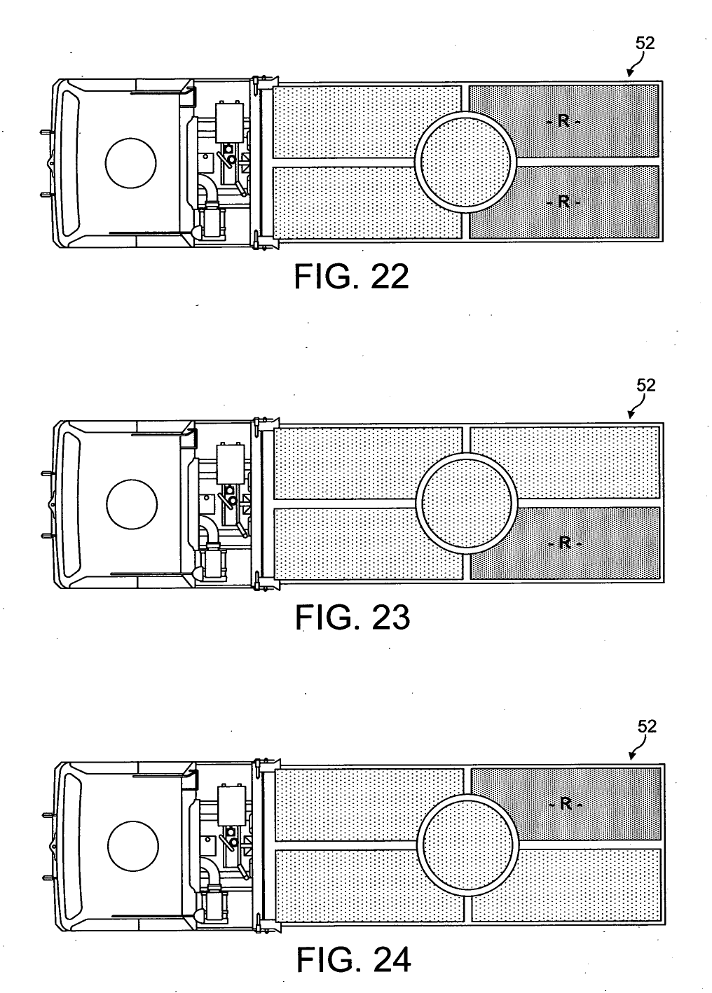

Various permutations of the information conveyed by the zones (521-525) are shown in FIGS. 7-24. A zone displaying a red colour is indicated by the inclusion of the symbol “-R-”.

If the zone (525) indicates that the payload module is in an overload condition, the payload module should be unloaded from the vehicle and some of the load removed. If any of the zones (521-524) indicate an offset of centre of gravity of the payload module, and the central circle (525) is not indicating an excessive mass, then the payload module should still be unloaded, but there is no need to actually remove any of the load, and instead the only requirement is to redistribute or reposition the load within the payload module (ISO container) in order to ensure that the centre of gravity of the payload module is sufficiently close to the central position such that, when the payload module is reloaded onto the vehicle, none of the zones (521-524) indicates that there is an off-centre centre of gravity any longer.

FIG. 31 diagrammatically illustrates the major components of the load monitoring system (5).

The load monitoring system (5) includes sensors (53). They include: a sensor (531) for sensing the extension length of the middle frame cylinders (26); a sensor (532) for sensing the extension length of the hook arm cylinders (27); a sensor (533) for sensing the hydraulic pressure of the middle frame cylinders (26); a sensor (534) for sensing the hydraulic pressure of the hook arm cylinders (27); a sensor (535) for sensing the lateral inclination of the vehicle (1); a sensor (536) for sensing the longitudinal inclination of the vehicle (1); a sensor (537) for sensing when the middle frame (21) is in its down position (e.g. as in FIG. 3); and a sensor (538) for sensing when the hook arm (23) is in its down position (e.g. as in FIG. 4).

The sensors (53) can all be fitted to the load handling system (2) or vehicle (1) without requiring the load handling system (2) to be taken off the vehicle chassis (11). The sensors (53) do not include any load cells which need to be fitted between the load handling system (2) and the chassis (11). Such load cells would be inconvenient to fit and would have the disadvantage of raising the height of the load handling system, thereby worsening the stability of the vehicle.

The load monitoring system (5) also includes a data processor (54) having a central processing unit (541) and a plurality of memories (542-545) which store data sets relating to the geometry of specific components. Memory (542) stores the geometry of the load handling system (2) and the vehicle (1). Memory (543) stores the geometry of an ISO container such as container (3). Memory (544) stores the geometry of a flatrack such as a NATO-specification flatrack. Memory (545) stores the geometry of an open-top skip body. Further memories may be added storing the geometries of other payload modules that are intended to be handled by the load handling system (2).

The central processing unit (541) stores the equations (algorithms) used to process the information received from the sensors (53) in combination with the data extracted from the memories (542-545) as appropriate in order to: calculate the position of the hook (25) in response to the sensed information from the sensors (531-532); calculate the position of the payload module (container 3) based on the calculated position of the hook (25) and the sensed information from the sensors (535-538); calculate the force imposed on the hook (25) by the container (3) based on the sensed information from the sensors (533-534); and finally calculate the longitudinal and lateral positions of the centre of gravity of the payload module taking into account the sensed information from the sensors (535-536) and also calculate the total mass of the payload module. The calculated positions of the centre of gravity and the total mass are then outputted by the CPU (541) for display on the display (51).

Initially, during the loading cycle, the calculated positions of the centre of gravity and the calculated mass of the payload module may be estimates. These estimates and the sensed information used to generate these estimates may be stored as a data set in a memory (5411) of the CPU (541).

The sensors (53) sense their information many times during the loading cycle (and preferably substantially continuously) and each successive sensing of information may result in the recalculation of the positions of the centre of gravity and the payload module mass in order to improve on the previously-calculated estimated values, until eventually final values can be produced that are substantially fixed and unlikely to change further.

The successive estimates and data sets resulting from the successive sensor samplings during the loading cycle may be stored in the memory (5411).

For example, at or shortly after initial pick-up of the payload module, it is possible to arrive at an estimate of the payload module mass. The final value may be calculated when the loading cycle has progressed further and none of the payload module is resting on the ground.

At or shortly after a “middle frame down” condition, it is possible to arrive at the final value of the longitudinal position of the centre of gravity of the payload module.

At or shortly after a “hook arm down” condition, it is possible to arrive at the final value of the lateral position of the centre of gravity of the payload module.

As soon as each final value is calculated, or as soon as an early estimate indicates a clearly excessive payload module mass or uneven load distribution, it is displayed as such on the display (51). Thus, it is possible during the loading operation, and before the loading cycle is completed, to present the operator of the vehicle with information relating firstly to the mass of the payload module (so that the operator can be alerted at an early stage if there is an overload) and secondly relating to the longitudinal position of the centre of gravity of the payload module (so that the operator can be alerted that one or more of the axles will be overloaded if the loading operation is completed).

The load monitoring system (5) also includes a loudspeaker (55) so that buzzers, spoken messages and the like can be used to warn the operator that a dangerous condition has been detected during the loading operation.

As shown in FIG. 31, the load monitoring system (5) may also interact with a vehicle control system (6) which is already installed in the vehicle (1). The load monitoring system (5) may be installed in the vehicle at the time of original manufacture of the vehicle and fitting of the load handling system (2).

Alternatively, the load monitoring system (5) may be fitted as an after-market option at a later date. Under these circumstances, it is advantageous for the load monitoring system (5) to be able to interact with the existing vehicle control system (6). In the illustrated embodiment, the load monitoring system (5) has an output line (56) which may be connected to the vehicle control system (6) so as to instruct the vehicle control system to stop movement of the load handling system (box 61) upon detecting an excessive payload module mass, to disable movement of the vehicle (box 62) upon detecting an excessively off-centre centre of gravity of the payload module, and to record an “event” in the service history log (box 63) to assist future maintenance of the vehicle.

The data processor (54) is reset at the beginning of the loading cycle, when the hook is fully back at initial pick-up and when the computation mode of the data processor is about to begin. It is also reset at the end of the loading cycle, when the payload module is in the fully-loaded transit position.

The calculations by the data processor may take into account environmental factors, such as wind loading which might influence the calculation regarding the location of the centre of gravity of the payload module, or temperature which might affect the viscosity of the hydraulic oil that passes through the volumetric flow sensors (531-532).

The lateral inclinometer (535) and longitudinal inclinometer (536) may comprise a two-axis inclinometer. Detecting lateral and longitudinal movements during loading by means of such an inclinometer can be used to compensate for the effect of the vehicle being initially on uneven ground, even though it is preferred that even ground is used when loading the vehicle.

Initial lateral and longitudinal inclination may be measured, in order to measure the slope and direction of slope of the ground that the vehicle is standing on, and these measurements may be used as correcting factors in the calculations performed by the data processor (54), in order to correct for the fact that the gravitational force is not perpendicular to the longitudinal and transverse axes of the vehicle.

The calculation by the load monitoring system (5) may be thought of as having several stages: load type recognition, load position recognition and loading force recognition.

To implement the load type recognition, additional sensors (53) could be provided in order to indicate whether the rear roller assemblies (28) are deployed for use, which would indicate that an ISO container is to be loaded. If the rear roller assemblies (28) are not deployed for use, the assumption would then be that the alternative option of using the rear rollers for a flatrack is to be used, so that the load monitoring system (5) could assume that a flatrack is to be loaded instead of an ISO container.

Load position recognition is based on knowing the current position of the hook (25). This can be calculated based on a knowledge of the load handling system and vehicle geometry (lengths of components, pivot positions etc). The current position of the hook is indicated by the extension length of the middle frame cylinders (26), and the extension length of the hook arm cylinders (27). These are known from the sensors (531, 532) which may measure the volume of oil that has flowed into the cylinders in question. Alternatively, sensors that directly measure extension length may be used. Alternatively, the position of the hook (25) may be calculated from sensors which measure the pivot angle of the middle frame (21) relative to the chassis (11) and the pivot angle of the hook arm (23) relative to the middle frame (21). The middle frame down sensor (537) and hook arm down sensor (538) may be used to confirm the current position of the load handling system. From the calculated position of the hook (25), and from the geometry of the load handling system on the vehicle and the geometry of the payload module, the current position of the payload module may be calculated.

Loading force recognition involves sensing the force imposed on the hook (25) by the external load (the demountable payload module) whose current position has been determined. The sensors (533, 534) measure the hydraulic pressure of the middle frame cylinders (26) and hook arm cylinders (27). The force on the hook (25) is related to the calculated payload module position such that equations (algorithms) can be set up to calculate the “unknowns” represented by the mass of the payload module and the longitudinal and lateral positions of the centre of gravity of the payload module (and, if desired, the height of the centre of gravity of the payload module). The equations cannot be solved by the sensed information sensed at just one position of the loading cycle.

By sensing the information at a plurality of positions (and preferably substantially continuously during the loading cycle) multiple sets of equations containing the desired “unknowns” may be set up and then solved, in order to arrive at values of the “unknowns”, i.e. the mass of the payload module, the lateral position of the centre of gravity of the payload module, the longitudinal position of the centre of gravity of the payload module and the height of the centre of gravity of the payload module. The calculated values may initially be estimates, but the estimates may be gradually refined until final values are arrived at as the loading cycle progresses and more sets of sensed information are obtained from the sensors (53).

In performing the loading force recognition, it is the sensors (533 and 534) that enable the hydraulic pressure of the middle frame cylinders (26) and the hook arm cylinders (27) to be measured. Alternatively, strain gauges in the cylinders and/or pivots of the load handling system (2) could be used in order to enable calculations to be performed to arrive at the force imposed on the hook (25) by the payload module (container 3).

The inclination information from the sensors (535, 536) may be factored into the equations (algorithms) particularly to assist with the calculation of the lateral position of the centre of gravity of the payload module.

The display (51) may be positioned in the cab (13), such as next to the cab-mounted control unit for the load handling system (2). Alternatively, a head up display (HUD) could be positioned in the line of sight of the driver. The display (51) could also be used to diagrammatically depict the progress of the loading of the payload module, e.g. using a series of icons depicting the payload module gradually being loaded onto the vehicle.

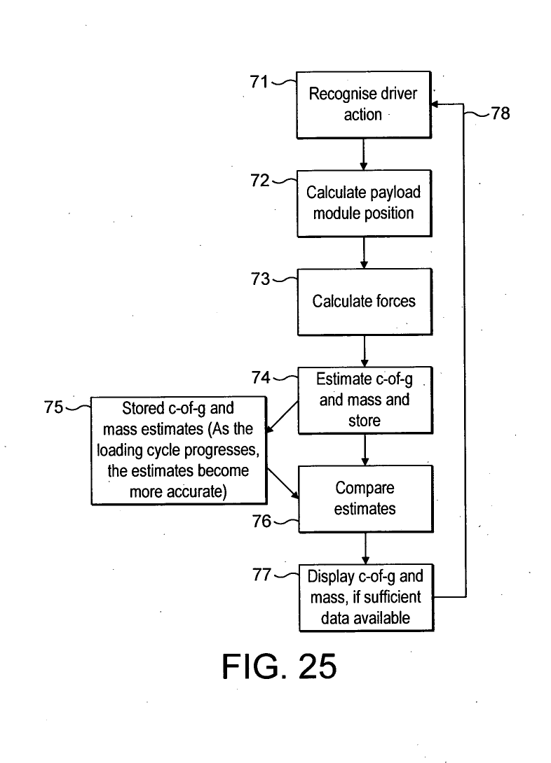

FIGS. 25-30 are a series of flow diagrams useful for understanding the operation of the load monitoring system (5).

FIG. 25 shows the general scheme of operation. In step (71), the load monitoring system recognises that the driver has initiated loading action. In step (72), the position of the payload module is calculated. In step (73), the loading force is calculated. In step (74), the centre of gravity positions and the mass of the payload module are calculated and stored. Previously-calculated centre of gravity positions and mass estimates are stored in box (75). In step (76), the previous estimates are compared with the newly-calculated estimates calculated in step (74). In step (77), if the newly-calculated values of the centre of gravity positions and mass are deemed to be sufficiently accurate, they are displayed on the display (51). This overall process is repeated, via loop (78), a plurality of times (e.g. a minimum of 2, 3, or 4 times) during the loading cycle and, preferably, is performed on a continuous basis throughout the loading cycle.

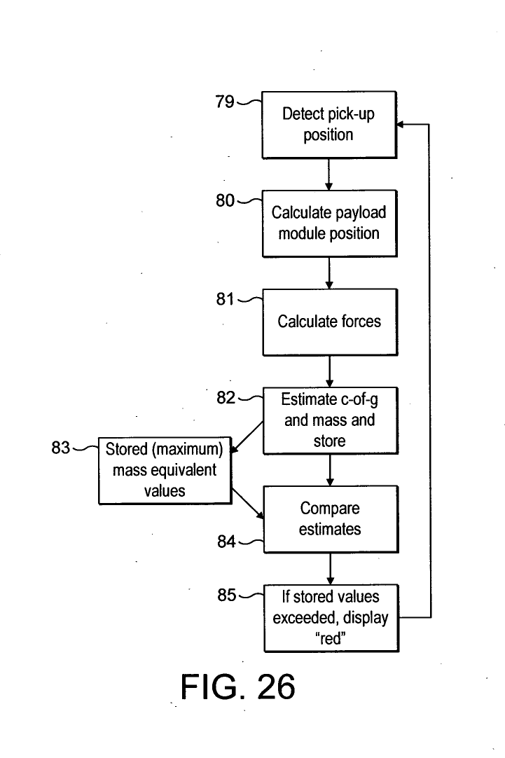

FIG. 26 illustrates the calculation procedure of the load monitoring system (5) at initial pick-up of the payload module. At step (79), the start of initial pick-up is detected, e.g. using the information from the sensors (531-536). In step (80), the payload module position is calculated. In step (81), the loading force imposed by the payload module on the hook (25) is calculated. In step (82), estimates are made of the centre of gravity positions and the mass of the payload module, and they are stored. An acceptable maximum mass for the payload module is stored in box (83). This maximum acceptable mass (threshold value for the mass) is compared with the actual estimated mass of the payload module calculated in step (82), and this comparison is performed in step (84). If the actual mass exceeds the maximum (threshold) value for an acceptable or safe mass, step (85) causes an output to be sent to the display (51) to display a red central circle (525) on the diagrammatic plan view (52).

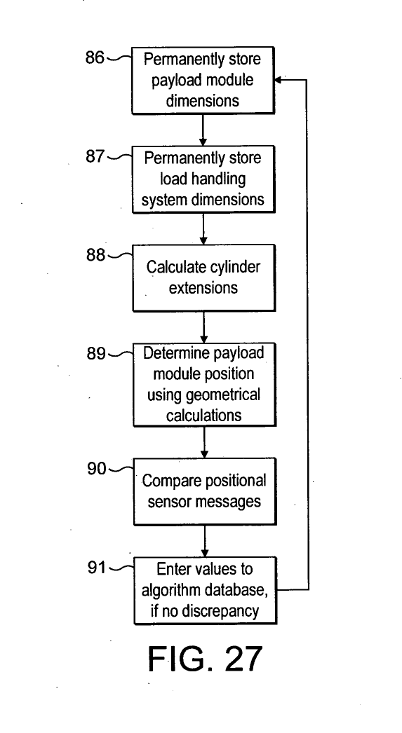

In FIG. 27, calculation of payload module position is shown. In step (86), the dimensions of the payload module are permanently stored (e.g. in memory 543, 544 or 545). In step (87), the dimensions of the load handling system are permanently stored (e.g. in memory 542). In step (88), the cylinder length extensions are calculated using the information from the sensors (531,532). In step (89), the payload module position is calculated using geometrical calculations. In step (90), the information from the middle frame down sensor (537) and hook arm down sensor (538) is used to check that the calculated payload module position (step 89) is plausibly correct. If the calculated position looks to be plausibly correct, the calculated payload module position is stored in the memory (5411) in step (91).

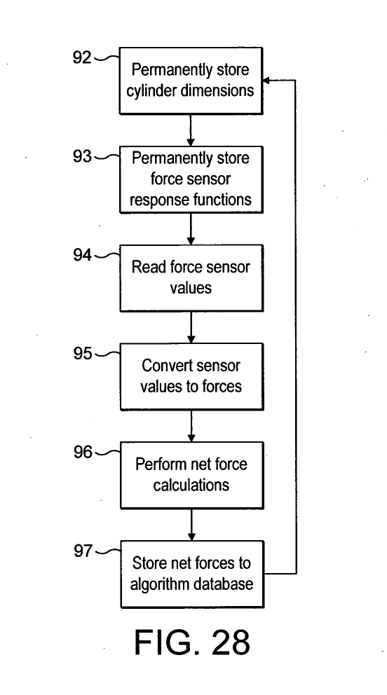

FIG. 28 illustrates the general principle for calculating the force imposed on the hook (25) by the payload module. In step (92), the cylinder dimensions are permanently stored, e.g. in the memory (542). In step. (93), the force sensor response functions of hydraulic pressure sensors (533, 534) are stored, e.g. in the memory (542). The current force sensor values are read in step (94). In step (95), they are converted into forces. In step (96), a calculation is performed in order to arrive at the force on the hook (25). All calculated forces are stored to the database (memory 5411) in step (97).

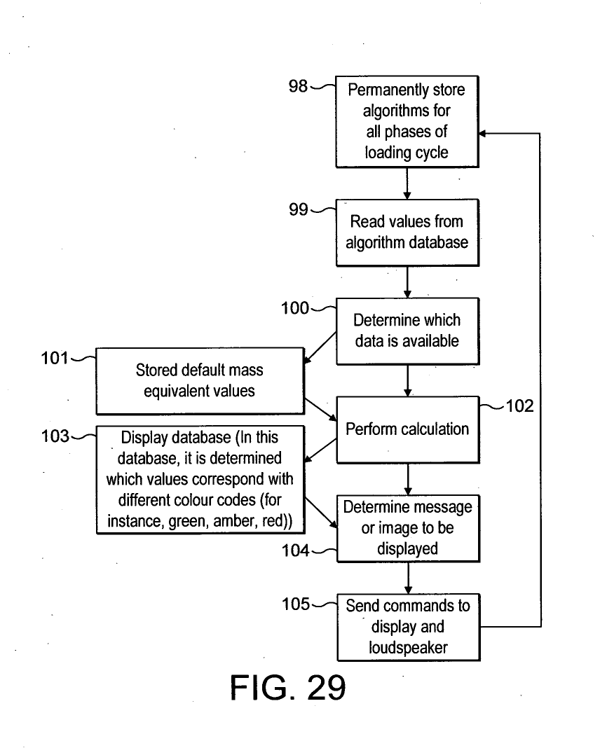

FIG. 29 illustrates the principles behind calculating the centre of gravity positions. In step (98), all of the algorithms (equations) are stored for the different positions (stages or phases) of the loading cycle. The relevant equations (algorithms) for the particular current payload module position are read in step (99). In step (100), the data available from the sensors (53) is assessed. If necessary, a stored default value for the payload module mass may be used (box 101). The calculation of the centre of gravity positions is performed in step (102) using the appropriate algorithms for the current calculated position of the payload module and previous data sets from memory (5411). A display database (103) is consulted to determine how to display the results of the calculation. In step (104), a decision is made as to whether a visual image (such as on diagrammatic plan view 52) is to be displayed or whether a message is to be displayed or whether a message is to be spoken by the loudspeaker (55). In step (105), appropriate commands are sent to the display (51) and/or loudspeaker (55).

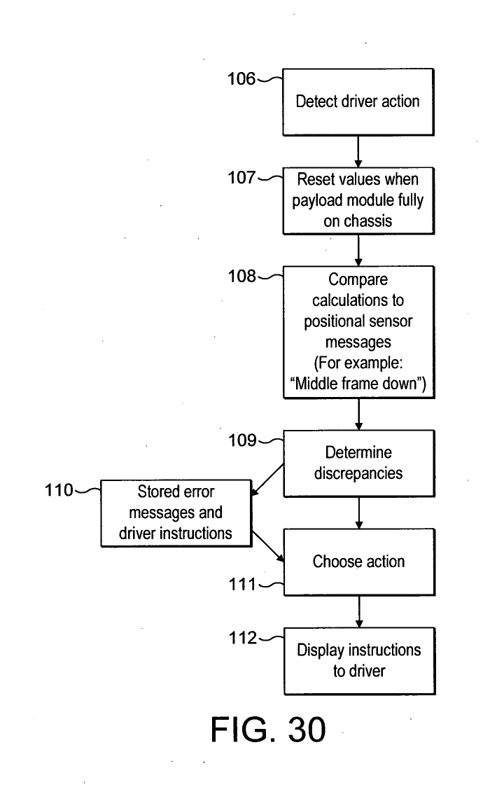

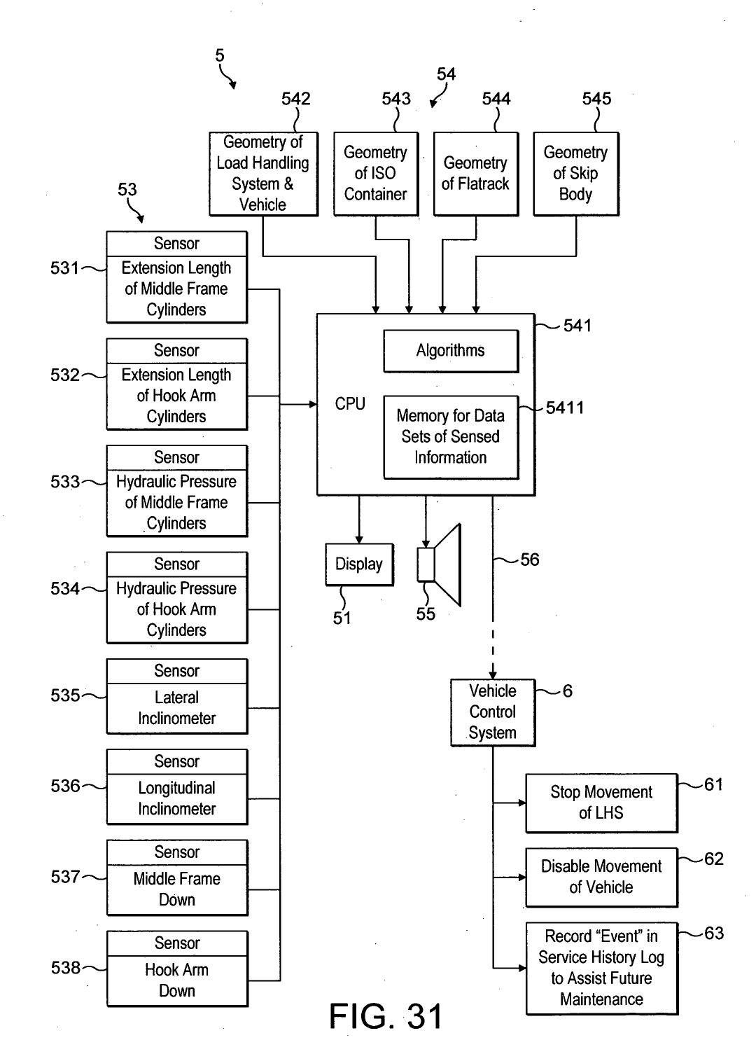

In FIG. 30, various functions are illustrated for maintaining the accuracy of the load monitoring system (5). In step (106), driver use of the load handling system is detected. In step (107), the algorithms or calculations in central processing unit (541) are reset when the payload module is fully loaded onto the chassis (11). In step (108), the outcome of the calculations to calculate a payload module position are compared with the positional information from the middle frame down sensor (537) and hook arm down sensor (538). In step (109), any discrepancies between the calculated and actually-sensed positions of the middle frame and hook arm are assessed for any discrepancies. If necessary, a database of stored error messages and driver instructions (box 110) is consulted and, in step (111), an appropriate alerting action is selected, and in step (112) a display on the display (51) is produced in order to provide information to the driver.

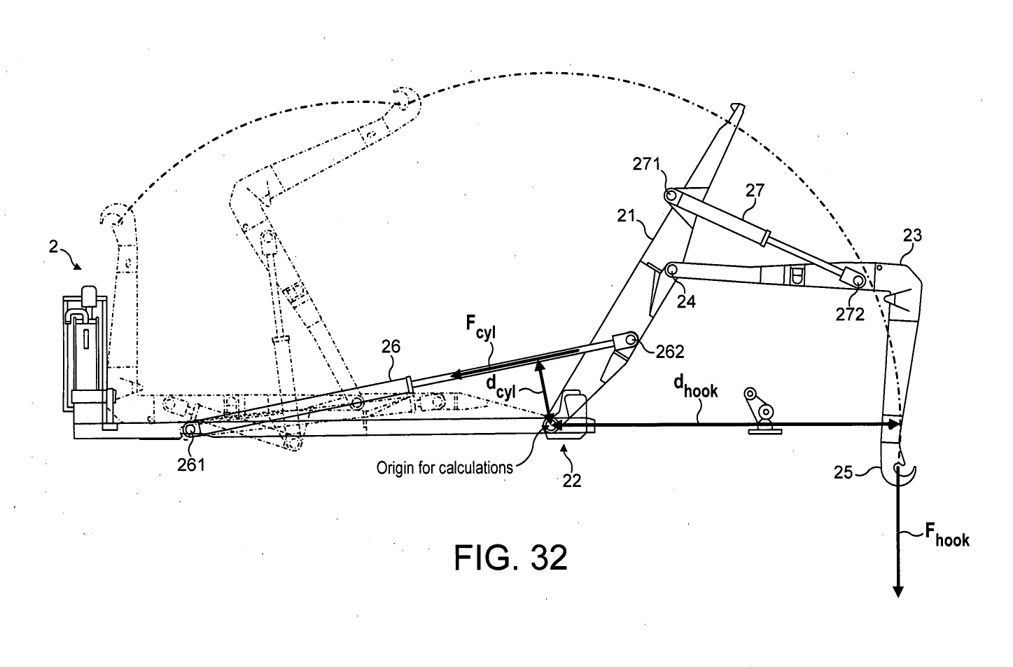

FIG. 32 illustrates how the data processor (54) may set up a static force equation for calculating, in step (81) of FIG. 26, the loading force (Fₕₒₒₖ) imposed by the payload module on the hook (25).

FIG. 32 shows just the load handling system (2) and does not show the vehicle (1) or container (3).

The equation specifies a balance of forces or an equilibrium:

Fₕₒₒₖ×dₕₒₒₖ=F_{cyl}×d_{cyl}

The position of the hook (25) can be calculated using trigonometry from the sensed angle of the middle frame (21), the sensed angle of the hook arm (23) and the geometry of the load handling system (2) such as the dimensions of the middle frame and hook arm. The position of the hook (25) enables dₕₒₒₖ and d_{cyl} to be calculated.

F_{cyl} is an internal force of the load handling system (2) and is the force exerted by the middle frame cylinders (26). It may be calculated from the equation:

F_{cyl}=(effective hydraulic pressure)×(effective pressurised cylinder area)

The hydraulic pressure is sensed by the sensors (533) and the effective pressurised cylinder area is a physical dimension or characteristic of the geometry of the load handling system (2).

Thus, the loading force (Fₕₒₒₖ) may be calculated by the data processor (54).

The above principle for setting up a static balance equation may be applied more generally by the data processor (54) in order to combine internal forces and positional data into equations (algorithms) to enable the position of the centre of gravity and the mass of the payload module to be calculated using the basic principles of trigonometry and statics.

If the load handling system is of the sliding hook arm type instead of the tilting hook arm type, the current position of the hook during load position recognition may be calculated using sensors which measure the pivot angle of the middle frame and the extension length of the sliding hook arm relative to the middle frame.

It will be appreciated that the above description is non-limiting and refers to the currently-preferred embodiments of the invention. Many modifications may be made to the preferred embodiments within the scope of the invention. Although features believed to be of particular significance are identified in the appended claims, the applicant claims protection for any novel feature or idea described herein and/or illustrated in the drawings, whether or not emphasis has been placed thereon. Furthermore, in relation to the appended claims, the features thereof may be combined together in permutations other than those currently laid out in the claims, including for example substituting a feature in one claim with a feature from another claim or with no feature.

1. A load monitoring system for use in monitoring the loading of a vehicle by a load handling system which is carried by the vehicle and is releasably connectable to a demountable payload module positioned on the ground and is movable through a loading cycle to load the payload module onto the vehicle from the ground, the load monitoring system comprising:
sensors for sensing positional information, loading force information and lateral inclination information of the load handling system at a plurality of positions during the loading cycle; and
a data processor constructed and arranged to determine the longitudinal position and the lateral position of the centre of gravity of the payload module and the mass of the payload module based on the positional information, loading force information and lateral inclination information sensed by the sensors during the loading cycle.

2-3. (canceled)

4. A load monitoring system according to claim 1, wherein the data processor is also constructed and arranged to determine the height of the centre of gravity of the payload module.

5. A load monitoring system according to claim 1, wherein the load monitoring system further comprises a sensor for sensing longitudinal inclination information of the load handling system.

6. A load monitoring system according to claim 1, wherein the load monitoring system further comprises a display and the data processor is constructed and arranged to produce a display output for displaying on the display information relating to the centre of gravity of the payload module and/or the mass of the payload module.

7. A load monitoring system according to claim 6, wherein the display output is arranged to display a diagrammatic plan view of the payload module depicting the location of the centre of gravity of the payload module.

8-10. (canceled)

11. A load monitoring system according to claim 1, wherein the load handling system is of the hook-lift type, and the sensors are arranged to sense positional information indicative of the position of the hook of the load handling system.

12. A load monitoring system according to claim 11, wherein the sensors are arranged to sense positional information comprising the extension length of middle frame cylinder(s) and the extension length of hook arm cylinder(s) of the load handling system.

13. A load monitoring system according to claim 11, wherein the sensors arranged to sense positional information comprise a sensor which detects a middle-frame-down condition and/or a sensor which detects a hook-arm-down condition.

14. A load monitoring system according to claim 1, wherein the load handling system is of the hook-lift type, and the sensors are arranged to sense loading force information comprising the hydraulic pressure of middle frame cylinder(s) and the hydraulic pressure of hook arm cylinder(s) of the load handling system.

15. A load monitoring system according to claim 1, wherein the data processor is arranged, at an early stage in the loading cycle, to produce estimates of the centre of gravity of the payload module and the mass of the payload module based on early-stage information sensed by the sensors, and at a later stage in the loading cycle to produce improved estimates based on later-stage information sensed by the sensors.

16. A load monitoring system according to claim 15, wherein the data processor is arranged repeatedly to produce improved estimates at successive stages in the loading cycle.

17. A load monitoring system according to claim 1, wherein the data processor is arranged to receive an input signal indicating the type of payload module to be loaded by the load handling system.

18. A load monitoring system according to claim 1, wherein the data processor is arranged to produce a control output for influencing the operation of the load handling system and/or vehicle based on the centre of gravity position and/or mass determined by the data processor.

19-20. (canceled)

21. A load monitoring system according to claim 1, wherein the data processor stores geometrical information relating to the geometry of the load handling system and the geometry of the payload module, and the data processor is constructed and arranged to determine the longitudinal position of the centre of gravity of the payload module and the mass of the payload module based also on the geometrical information.

22. A load monitoring system according to claim 21, wherein the data processor is constructed and arranged to determine the lateral position of the centre of gravity of the payload module based also on the geometrical information.

23. A load monitoring system according to claim 21, wherein the data processor is constructed and arranged to determine the height of the centre of gravity of the payload module based also on the geometrical information.

24. (canceled)

25. A load handling system of the hook-lift type fitted with a load monitoring system according claim 1.

26. A load handling system of the hook-lift type having a tilting hook arm and fitted with a load monitoring system according to claim 1.

27. (canceled)

28. A method of monitoring the loading of a vehicle by a load handling system which is carried by the vehicle, wherein after the load handling system has been releasably connected to a demountable payload module positioned on the ground and the load handling system starts to move through a loading cycle to load the payload module onto the vehicle:
positional information, loading force information and lateral inclination information of the load handling system are sensed at successive positions of the loading cycle; and
the positional, loading force and lateral inclination information from the successive positions are processed to determine the longitudinal position and the lateral position of the centre of gravity of the payload module and the mass of the payload module.

29. A method of retrofitting a load monitoring system to a vehicle having a chassis on which is mounted a load handling system which is releasably connectable to a demountable payload module positioned on the ground and is movable through a loading cycle to load the payload module onto the vehicle from the ground, the method comprising:—
fitting, to the load handling system, sensors for sensing positional information, loading force information and lateral inclination information of the load handling system during the loading cycle, wherein the sensors are fitted without demounting the load handling system from the chassis; and
connecting, to the sensors, a data processor for determining the longitudinal position and the lateral position of the centre of gravity of the payload module and the mass of the payload module by processing the positional information, loading force information and lateral inclination information sensed by the sensors during the loading cycle.

30-34. (canceled)
